(19) United States
(12) Patent Application Publication
(10) Pub. No.: US 2018/0215879 A1
(43) Pub. Date: Aug. 2, 2018

(54) N,N-Dialkyl glucamine for stabilising polymer dispersions

(71) Applicant: CLARIANT INTERNATIONAL LTD., Muttenz (CH)

(72) Inventors: Rainer KUPFER, Hattersheim (DE); Christoph SÖFFING, Mettmann (DE)

(73) Assignee: Clariant International Ltd., Muttenz (CH)

(21) Appl. No.: 15/744,645

(22) PCT Filed: Jun. 13, 2016
(86) PCT No.: PCT/EP2016/063433

§ 371 Date: Jan. 12, 2018

(30) Foreign Application Priority Data
Jul. 14, 2015 (DE) 10 2015 213 123.8

(51) Int. Cl. C08J 3/03

(52) U.S. Cl. CPC C08J 3/03; C08J 2333/08; C08J 2333/12

(57) ABSTRACT

The invention relates to the use of an amine base as neutralisation agent for polymer dispersions, characterised in that the amine base used corresponds to the formula (I),

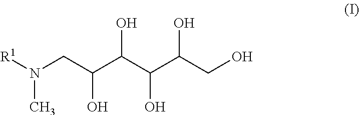

where R¹ represents C₁-C₄-alkyl, CH₂CH₂OH or CH₂CH(CH₃)OH.

The present invention relates to low-VOC, tertiary amines from renewable raw materials for stabilizing aqueous polymer dispersions against electrolytes.

Polymer dispersions have many uses for film formation in emulsion paints and printing inks, adhesives, textile and leather coating and also in paper coating and upgrading. For this purpose, the dispersions have to be stable to environmental influences and also to typical formulation constituents in the end applications.

According to the prior art, polymer dispersions are typically neutralized using alkali metal hydroxides or ammonia.

DE-1956509 teaches polymer dispersions which are stabilized by neutralization with alkanolamines and form homogeneous films even at room temperature.

EP-1177223 teaches aqueous polymer dispersions whose anionic groups have been neutralized with N-methylglucamine.

EP-0614881, U.S. Pat. No. 5,449,770 and U.S. Pat. No. 2,016,962 describe methods for preparing glucamines from glucose.

EP-1676831 describes tertiary N,N-dialkylglucamines such as N,N-diethyl-glucamine and relatively long-chain dialkylamines for use as emulsifier, wetting agent and dispersant for applications in coatings, inks, adhesives, agricultural formulations, shampoos and cleaners and also in oil recovery or in cement processing.

A disadvantage of the neutralizing agents described in the prior art is that they have only limited electrolyte stability.

It was therefore an object of the present invention to increase the stability of polymer dispersions toward electrolytes such as CaCO₃, which are customarily used as fillers in paints or adhesives.

It has now surprisingly been found that polymer dispersions whose pH is set by means of N,N-dialkylamines have improved electrolyte stability over a wider temperature range than the comparative examples ammonia and N-methyl-glucamine.

The invention accordingly provides for the use of an amine base for neutralization of a polymer dispersion, wherein the amine base used corresponds to the formula (I)

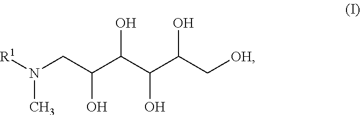

where R¹ is C₁-C₄-alkyl, CH₂CH₂OH or CH₂CH(CH₃)OH.

R¹ is preferably methyl or CH₂CH₂OH.

The polyhydroxy unit is a hexose, preferably the epimer glucose.

The compounds of the formula (I) can be used as pure substances or as aqueous solutions. The tertiary amines such as N,N-dimethylglucamine, N-hydroxyethyl- and N-hydroxypropyl-N-methylglucamine have little susceptibility to formation of nitrosamines and are to be preferred.

The polymer dispersion is a homopolymer or copolymer of olefinically unsaturated monomers. Preferred olefinically unsaturated monomers are, for example,
vinyl monomers, such as carboxylic esters of vinyl alcohol, for example vinyl acetate, vinyl propionate, vinyl ethers of isononanoic acid or of isodecanoic acid, which are also referred to as C₉- and C₁₀-versatic acids,
aryl-substituted olefins such as styrene and stilbene, olefinically unsaturated carboxylic esters such as methyl acrylate, ethyl acrylate, propyl acrylate, n-butyl acrylate, i-butyl acrylate, pentyl acrylate, hexyl acrylate, 2-ethylhexyl acrylate, tridecyl acrylate, stearyl acrylate, hydroxyethyl acrylate, hydroxypropyl acrylate and the corresponding methacrylic esters,
olefinically unsaturated dicarboxylic esters such as dimethyl maleate, diethyl maleate, dipropyl maleate, dibutyl maleate, dipentyl maleate, dihexyl maleate and di-2-ethylhexyl maleate,
olefinically unsaturated carboxylic acids and dicarboxylic acids such as acrylic acid, methacrylic acid, itaconic acid, maleic acid and fumaric acid and sodium, potassium and ammonium salts thereof,
olefinically unsaturated sulfonic acids and phosphonic acids and alkali metal and ammonium salts thereof, e.g. vinylsulfonic acid, vinylphosphonic acid, acrylamidomethylpropanesulfonic acid and alkali metal and ammonium, alkylammonium and hydroxylalkylammonium salts thereof, allylsulfonic acid and alkali metal and ammonium salts thereof, acryloyloxethylphosphonic acid and ammonium and alkali metal salts thereof and also the corresponding methacrylic acid derivatives,
olefinically unsaturated amines, ammonium salts, nitriles and amides, e.g. dimethylaminoethyl acrylate, acryloyloxethyltrimethylammonium halides, acrylonitrile, acrylamide, methacrylamide, N-methylacrylamide, N-ethyl-acrylamide, N-propylacrylamide, N-methylolacrylamide and the corresponding methacrylic acid derivatives and vinylmethylacetamide,
olefins or halogenated olefins having from 2 to 6 carbon atoms, e.g. ethylene, propene, butene, pentene, 1,3-butadiene, chloroprene, vinyl chloride, vinylidene chloride, vinylidene fluoride and tetrafluoroethylene.

In a further preferred embodiment, at least one of the olefinically unsaturated monomers contains an anionic group. In a particularly preferred embodiment, the anionic group is an acrylate.

The invention further provides a method of improving the electrolyte stability of polymer dispersions, wherein >0.01%, preferably 0.01-10%, in a particularly preferred embodiment 0.01-5%, of the amine base (I) is added to the polymer dispersion. The addition of the base can be carried out during the polymerization or afterward. The percentages refer to the weight of the compound of the formula (I).

The dispersions according to the invention are suitable for producing coatings of all types. The dispersions according to the invention are particularly suitable for producing paints, printing inks and emulsion paints, emulsion varnishes and also adhesives and sealants.

### EXAMPLES

### Determination of the Electrolyte Stability:

To determine the electrolyte stability, a 5% strength CaCl₂ solution is stirred into the polymer dispersion (1:1 w/w). The mixture is immediately visually checked for coagulum formation after the addition of the CaCl₂ solution is complete. If the mixture is still homogeneous, the polymer dispersion is introduced into a measuring cylinder, closed so as to be airtight and checked again for homogeneity after 24 hours; if no coagulation is found, the dispersion is heated stepwise and in each case stored for 24 hours at the corresponding temperature.

### Determination of the Freeze-Thaw Stability:

To determine the freeze-thaw stability, the polymer dispersion is frozen at −18° C. for 8 hours. It is subsequently warmed to room temperature and checked visually for coagulum and speck formation.

### Determination of the Storage Stability

To determine the storage stability, the dispersion is stored at 50° C. for 7 days in an oven. The dispersion is subsequently cooled to room temperature (20-25° C.) and assessed visually for phase separation and speck formation.

### Preparation of the Pure Acrylate Dispersion:

To produce the initiator solution, 2.3 g of potassium peroxodisulfate were dissolved in 74.5 g of deionized water.

To prepare the monomer emulsion, 285 g of deionized water, 22.5 g of Emulsogen EPA 073, 19.0 g of nonionic emulsifier, 6.0 g of sodium hydrogencarbonate, 380 g of n-butyl acrylate, 380 g of methyl methacrylate and 7.6 g of methacrylic acid are combined in succession with vigorous stirring.

In the reaction vessel, 312 g of deionized water and 11.3 g of Emulsogen EPA 073 are heated to 80° C. while stirring in a nitrogen atmosphere. 19.2 g of the initiator solution and 27.5 g of the monomer emulsion are subsequently added, and after a further 15 minutes the remaining initiator solution and monomer emulsion are added at a uniform rate over a period of 3 hours. After the addition is complete, the mixture is stirred at 80° C. for a further 6 minutes and cooled to room temperature. The reaction mixture is filtered to determine coagulum, divided into three equal parts and neutralized with different bases.

### Preparation of the Styrene-Acrylate Dispersion

To produce the initiator solution, 3.8 g of ammonium peroxodisulfate were dissolved in 98.5 g of deionized water.

To prepare the monomer emulsion, 284 g of deionized water, 22.5 g of Emulsogen EPA 073, 21.7 g of nonionic emulsifier, 4.0 g of sodium hydrogencarbonate, 342 g of styrene, 418 g of n-butyl acrylate and 7.6 g of methacrylic acid are combined in succession with rigorous stirring. In the reaction vessel, 286 g of deionized water and 11.3 g of Emulsogen EPA 073 are heated to 80° C. while stirring in a nitrogen atmosphere. 25.6 g of the initiator solution and 27.5 g of the monomer emulsion are subsequently added, and after a further 15 minutes the remaining initiator solution and monomer emulsion are added at a uniform rate over a period of 3 hours. After the addition is complete, the mixture is stirred at 80° C. for a further 6 minutes and cooled to room temperature. The reaction mixture is filtered to determine coagulum, divided into three equal parts and neutralized with different bases.

In a comparative trial, different emulsion polymers were prepared and neutralized to pH 7 using the amine bases ammonia, N-methylglucamine (NMG) and N,N-dimethylglucamine (DMG).

It was surprisingly found that dialkylglucamines display better electrolyte stabilities than the comparative examples ammonia and NMG.

| | | | | | Electrolyte | | | | | | |
|---|---|---|---|---|---|---|---|---|---|---|---|
| | | | | | stability at room | | Electrolyte | | | | |
| | | | | | temperature | | stability after | | | Freeze- | |
| | Monomer | Nonionic | | Coagulum | | after | 24 h at [° C.] | | | thaw | Storage |
| Ex. | system | emulsifier | Base | >40 μm | Immediately | 24 h | 40 | 60 | 80 | stability | stability |
| 1 (C) | Pure | Arkopal | Ammoniacal solution | 2853 ppm | stable | stable | stable | stable | solid | solid | stable |
| | acrylate | N 238 | (25% strength) | | | | | | | | |
| 2 (C) | | | NMG | | stable | stable | stable | stable | solid | solid | stable |
| 3 | | | DMG | | stable | stable | stable | stable | stable | solid | stable |
| 4 (C) | Pure | Emulsogen | Ammoniacal solution | 5646 ppm | stable | stable | stable | stable | solid | solid | stable |
| | acrylate | LCN 118 | (25% strength) | | | | | | | | |
| 5 (C) | | | NMG | | stable | stable | stable | stable | solid | solid | stable |
| 6 | | | DMG | | stable | stable | stable | stable | stable | solid | stable |
| 7 (C) | Pure | Emulsogen | Ammoniacal solution | 238 ppm | stable | stable | stable | stable | solid | solid | stable |
| | acrylate | LCN 287 | (25% strength) | | | | | | | | |
| 8 (C) | | | NMG | | stable | stable | stable | stable | solid | solid | stable |
| 9 | | | DMG | | stable | stable | stable | stable | stable | solid | stable |
| 10 (C) | Styrene- | Emulsogen | Ammoniacal solution | 1327 ppm | stable | stable | stable | stable | solid | solid | stable |
| | acrylate | LCN 287 | (25% strength) | | | | | | | | |
| 11 (C) | | | NMG | | stable | stable | stable | stable | solid | solid | stable |
| 12 | | | DMG | | stable | stable | stable | stable | stable | solid | stable |

1. A neutralizing agent for a polymer dispersion comprising an amine base, wherein the amine base corresponds to the formula (I), 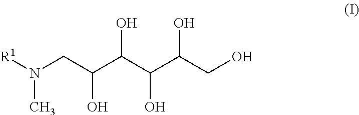
where R¹ is C₁-C₄-alkyl, CH₂CH₂OH or CH₂CH(CH₃)OH.

2. The neutralizing agent as claimed in claim 1, wherein R¹ is methyl or CH₂CH₂OH.

3. The neutralizing agent as claimed in claim 1, wherein R¹ is methyl.

4. The neutralizing agent as claimed in claim 1, wherein the concentration of the amine base of the formula (I) is from 0.01 to 10% by weight.

5. The neutralizing agent as claimed in claim 1, wherein the amount of the amine base of the formula (I) is from 0.01 to 5% by weight, based on the weight of the polymer dispersion.

6. The neutralizing agent as claimed in claim 1, wherein the concentration of the amine base of the formula (I) is from 0.01 to 1% by weight, based on the weight of the polymer dispersion.

7. The neutralizing agent as claimed in claim 1, wherein the polymer dispersion contains at least one anionic group.

8. The neutralizing agent as claimed in claim 7, wherein the anionic group in the polymer dispersion is an acrylate group.

9. The neutralizing agent as claimed in claim 1, wherein the pH of the neutralized dispersion is ≥7.

10. The neutralizing agent as claimed in claim 1, wherein the pH of the neutralized dispersion is >7.

11. A method of increasing the electrolyte stability of polymer dispersions, wherein ≥0.01% of an amine base of the formula (I) is added to a polymer dispersion, 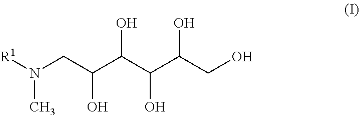
where R¹ is C₁-C₄-alkyl, CH₂CH₂OH or CH₂CH(CH₃)OH.

12. The method as claimed in claim 11, wherein the amine base of the formula (I) is used in an amount of from 0.01 to 10% by weight, based on the weight of the polymer dispersion.

13. The method as claimed in claim 11, wherein the amine base of the formula (I) is used in an amount of from 0.01 to 5% by weight, based on the weight of the polymer dispersion.

14. The method as claimed in claim 11, wherein R¹ is methyl or CH₂CH₂OH.

15. The method as claimed in claim 11, wherein R¹ is methyl.

16. The method as claimed in claim 12, wherein R¹ is methyl or CH₂CH₂OH.

17. The method as claimed in claim 13, wherein R¹ is methyl or CH₂CH₂OH.
